(19) United States
(12) Patent Application Publication
(10) Pub. No.: US 2012/0211261 A1
(43) Pub. Date: Aug. 23, 2012

(54) LAYERED ACTUATOR

(76) Inventors: Alvo Aabloo, Tartu (EE); Friedrich Kaasik, Tartu (EE); Viljar Palmre, Haaslava Parish (EE); Janno Torop, Tartu (EE)

(21) Appl. No.: 13/503,986

(22) PCT Filed: Oct. 26, 2010
(86) PCT No.: PCT/EE2010/000017

§ 371 Date: Apr. 25, 2012

(30) Foreign Application Priority Data
Oct. 26, 2009 (EE) P200900080

(51) Int. Cl. H01B 5/00

(52) U.S. Cl. 174/126.1

(57) ABSTRACT

The layered actuator comprises at least two electrode layers and an electronically nonconductive membrane in between, where the electrode layer contains carbide-derived carbon, a polymer material and an ionic liquid. The layered actuator bends due to relocation of the membrane ions when direct current is applied to the electrodes.

### TECHNICAL FIELD

The invention belongs to the field of actuators that are based on electroactive materials and bend when direct current is applied.

### STATE OF THE ART

Ionic polymer-metal composite (IPMC) actuators (U.S. Pat. No. 5,268,082) are known. These consist of two electrodes, which are layers of precious metal that conduct electricity, and a membrane, which is an ion-conducting polymer between the electrodes. The ion-conducting polymer layer, which contains water as a solvent, bends or deforms when direct current is applied to the electrode layers. The main drawbacks of such actuators are that these are difficult to make, the electrode materials do not endure repeated deformation for long and the fact that water, i.e. the solvent in the polymer, evaporates when the actuator is operated outside water environment, thus making the actuator non-functional.

Therefore, water-free actuators where ionic liquids are used as a solvent have been researched. Such actuators operate in ordinary conditions as well and are much more stable in time. The use of ionic liquids in IPMC actuators has been described in patent application No. US20050103706 and the following publications: B. J. Akle, M. D. Bennett and D. J. Leo, High-strain ionomeric-ionic liquid electroactive actuators, Sens. Actuators A: Phys. 126 (2006), pp. 173-181; M. D. Bennett and D. J. Leo, Ionic Liquids as Solvents for Ionic Polymer Transducers, Sensors and Actuators A: Physical, Vol. 115. pp. 79-90 (2004); Matthew D. Bennett, Donald J. Leo, Garth L. Wilkes, Frederick L. Beyer and Todd W. Pechar, A model of charge transport and electromechanical transduction in ionic liquid-swollen Nafion membranes, Polymer, Volume 47, Issue 19,2006, pp. 6782-6796.

Also known are actuators that are based on the bending or deformation of an ion-conducting polymer membrane (US20070114116), and the electrode material of which is fine carbon powder (carbon black) that is bound with an ion-conducting polymer (resin) or an electron-conducting organic polymer (polypyrrole). For better results, carbon black electrodes may be covered with a sheet of precious metal (gold or platinum).

B. Akle et al have proposed a direct assembly process for making actuators. This made it possible to use various high specific surface materials (ruthenium(IV)oxide, carbon nanotubes, carbon black, etc.) in IPMC electrodes. The use of the direct assembly process in making such actuators is described in patent application No. US20060266642 and the following publications. B. J. Akle, M. D. Bennett, D. J. Leo, K. B. Wiles, J. E. McGrath, Direct assembly process: A novel fabrication technique for large strain ionic polymer transducers, Journal of Materials Science 42 (16) (2007) 7031-7041; B. J. Aide, M. D. Bennett and D. J. Leo, High-strain ionomeric-ionic liquid electroactive actuators, Sens. Actuators A: Phys. 126 (2006), pp. 173-181; B. Aide, S. Nawshin, D. Leo, Reliability of high strain ionomeric polymer transducers fabricated using the direct assembly process, Smart Materials and Structures 16 (2007) S256-S261. According to this method, the electrode layers are applied onto the ionic liquid-containing polymer membrane by pulverisation followed by hot pressing of the material. In general, an additional metal layer (e.g. gold foil) is added onto the surface of the electrode during hot pressing. The polymer membrane may be treated with an ionic liquid either before or after hot pressing.

One known method is that of making thin films consisting of an ionic liquid, a polymer and carbon nanotubes and making layered actuators out of these films. This method is described in U.S. Pat. No. 7,315,106 and the following articles: K. Mukai, K. Asaka, T. Sugino, K. Kiyohara, I. Takeuchi, N. Terasawa, D. N. Futaba, K. Hata, T. Fukushima, T. Aida, Adv. Mater. 20 (2009) 1-4; I. Takaeuchi, K. Asaka, K. Kiyohara, T. Sugino, N. Terasawa, K. Mukai, T. Fukushima, T. Aida, Electromechanical behavior of fully plastic actuators based on bucky gel containing various internal liquids, Elecrochimica Acta 54 (2009) 1762-1768. Actuatros using double-layer charging of high specific surface carbon nanotubes is described in U.S. Pat. No. 6,555,945. This low-voltage actuator has a layered structure where carbon nanotubes are used as an electron-conducting material. However, the synthesis of carbon nanotubes cannot be controlled adequately and produces a wide variety of carbon nanotubes of various sizes. This means that costly methods are needed to separate the tubes that have the required characteristics.

The methods for the synthesis of nanoporous carbide-derived carbon (CDC) and the use of the foils made of synthesised powders in super capacitor applications is described in U.S. Ser. No. 11/407202, WO 2005/118471 and WO 2004/094307 and in the following article: Gogotsi, Y., Nikitin, A., Ye, H., Zhou, W., Fischer, J. E., Yi, B., Foley, H. C., Barsoum, M. W. Nanoporous carbide-derived carbon with tunable pore size, Nature Materials 2003, 2, 591. The carbide derived carbon is a nanostructural (it is classified by the International Union of Pure and Applied Chemistry (IUPAC) as a microporous material) carbon material that has been synthesised from a metal or non-metal carbide, that has a high special surface area (800-2000 cm²/g, up to 2500 cm²/g if post-processed) and an average pore size between 0.3 and 2 nm, and the macrostructure and microstructure of which follows the shape and size of the original carbide. During the production of carbide-derived carbon, the nanostructure of the carbon material can be adjusted through adjusting the controllable parameters, and the size of the nanopores can be fine-tuned (from 0.6 nm to 0.7 nm) as well as the distribution of their size. The capacity of the electrical double-layer of carbide-derived carbon is high and stable in time, and carbide-derived carbon is electroactive.

Unlike the state-of-the-art solutions, the electrodes of composite material functioning as an actuator in this invention contain an adequate amount of nanoporous carbide-derived carbon. The electron-conducting and ion-conducting polymeric material is made of an ionic liquid, a porous polymer and carbide-derived carbon. The production of nanoporous carbide-derived carbon is considerably easier, more accurately controllable and requires fewer resources than the production of carbon nanotubes.

### SUMMARY OF THE INVENTION

The actuator (10) according to this invention comprises two electrode layers (2 and 4), which contain carbide-derived carbon, and a polymer and an ionic liquid as the binding material.

The electrode layers are divided by a porous polymer membrane (3) that contains ionic liquid. The electrode layers contain 5-40% by weight, preferably 10-30% by weight, of carbide-derived carbon (CDC). A bigger amount of CDC in the electrode layer makes the actuator stronger, but the smaller amount makes it bend faster. The electrode layers may contain an adequate amount (preferably up to 10% by weight) of activated carbon, which improves the conductivity of the electrode layer. The electrode layers contain 20-35% by weight of polymer (or gel) material as a binding material and 30-50% by weight of ionic liquid. The appropriate polymeric materials and ionic liquids are mentioned in the invention implementation examples.

If direct current is applied to contacts 1 and 5, an electric field is created in the material and this makes the ions relocate and the material bends (see FIG. 2). If the polarity of the direct current applied is reversed, the material bends in the opposite direction.

### BRIEF DESCRIPTION OF DRAWINGS

FIG. 1. A cross-section of the composite containing carbide-derived carbon.

FIG. 2. Bending of the composite upon application of direct current.

FIG. 3. The scheme of the measuring device used for recording movements of the actuator.

FIG. 4. The scheme of connection of the actuator to a force transducer.

FIG. 5. U—voltage (V), I—current (mA×10), N—force transducer signal (V), Time—time (s).

### EXAMPLE OF THE EMBODIMENT OF THE INVENTION

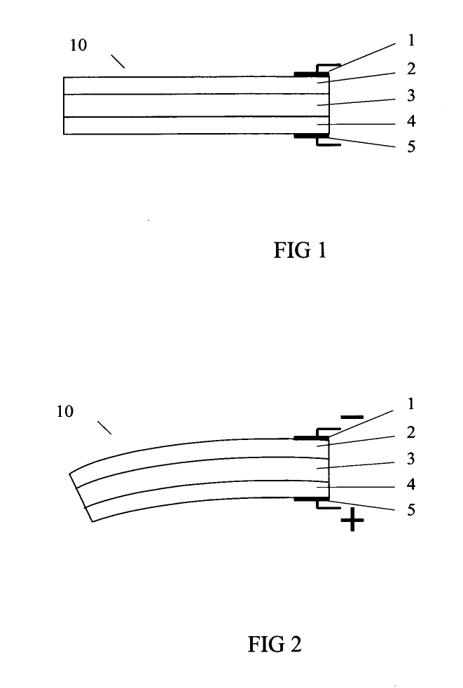

The layered actuator (10) that comprises a composite material is depicted in FIGS. 1 and 2. The actuator comprises two electrode layers (2 and 4), which contain carbide-derived carbon, and a polymer and an ionic liquid as the binding material. The electrode layers are divided by a porous polymer membrane (3) that contains ionic liquid. Contacts 1 and 5 have been connected to the electrode layers. If direct current is applied to the contacts, an electric field is created in the material. This makes the ions relocate and the material bends. If the polarity of the direct current applied is reversed, the material bends in the opposite direction.

The following are some examples of how to make an actuator.

### Example 1

Example 1 describes how to make the composite material containing carbide-derived carbon.

In this example, the nanoporous CDC, which had been synthesised from titanium carbide at 800° C. from Carbon Nanotech was used as the conductive component of the electrode. Polyvinylidene fluoride-hexafluoropropylene (PVdF-HFP) from Sigma Aldrich was used as a binding material and it was dissolved using N,N-dimethylacetamide (DMAc) as a solvent. 1-ethyl-3-methylimidazolium tetrafluorobroate (EMIBF₄) was used as an ionic liquid.

(a) Making Electrodes

The electrodes described in the example contain PVdF-HFP 35%, EMIBF₄ 35% and CDC 30% by weight.

To make the electrodes, 0.1 g of PVdF-HFP was dissolved in 1.5 ml of DMAc. An amount of carbide-derived carbon and an amount of ionic liquid (EMIBF₄), which were appropriate for the amount of polymer, were taken, 0.5 ml of DMAc was added and the resulting mixture was processed in an ultrasound bath for 25 minutes. Then, the polymer solution prepared earlier was added to the suspension of CDC and ionic liquid. The mixture was stirred with a magnetic stirrer and processed again in an ultrasound bath for 20 minutes. After the mixture had turned into a consistent suspension, the mixture was poured into a polytetrafluoroethylene (PTFE) mould and put into a fume cupboard to harden.

(b) Making a Polymer Membrane

The polymer membrane consists of PVdF-HFP 50% and EMIBF₄ 50% by weight. 0.15 g of PVdF-HFP was taken and dissolved in 1.5 ml of DMAc. Then, the ionic liquid was added to the dissolved polymer and the mixture was processed in an ultrasound bath for 30 minutes. Thereafter, the mixture was poured into a polytetrafluoroethylene (PTFE) mould to harden.

(c) Hot Pressing of the Material

The polymer films prepared were placed on top of each other in the order shown in FIG. 1 (the polymer membrane between the carbon electrodes) and hot-pressed at 120° C. and ˜20 MPa for 10 seconds. The edges of the layered composite material that formed were made smooth to avoid short-circuiting of the electrodes.

### Example 2

The actuator has been prepared as described in example 1, but the electrodes contain PVdF-HFP 32%, CDC 20% and EMIBF₄ 48% by weight.

### Example 3

The actuator has been prepared as described in example 1, but the electrodes contain PVdF-HFP 32%, CDC 10%, organic-activated carbon 10% and EMIBF₄ 48% by weight. The organic-activated carbon is added to improve the conductivity of the electrodes and it is derived through pyrolysis of a carbon-rich material, e.g. nutshells or wood, and the following activation, or through impregnation of a carbon-rich material with a strong acid, base or salt and the subsequent carbonisation.

### Example 4

The actuator has been prepared as described in example 1, but one electrode contains PVdF-HFP 32%, CDC 20% and EMIBF₄ 48% by weight and the other electrode contains PVdF-HFP 32%, CDC 20% and 1-octyl-3-methylimidazolium tetrafluoroborate (OMIBF₄) 48% by weight. The polymer membrane consists of PVdF-HFP 50%, EMIBF₄ 25% and OMIBF₄ 25% by weight.

### Example 5

A 16 mm×6 mm piece was cut out of the composite prepared according to examples 1-4 and this was used as an actuator.

Examples 6 and 7 describe the functioning of an actuator that is made of the invented composite. The characteristics of the actuator were measured using a measuring system (see measuring methods).

### Example 6

±2.8 V of DC was applied to an actuator that had been prepared according to example 5. The current consumed by the actuator and the voltage of the force transducer (FIG. 5) were recorded. After the respective conversions, the force created by the actuators was determined to be 76 mN (in one direction from the equilibrium position) and 82 mN (in the other direction).

### Example 7

±2.8 V of DC was applied to an actuator prepared according to example 2. The movement was recorded in a video on the basis of which the extent of movement of the actuator (strain) was calculated using a formula (1). The strain in one direction was 1.2% and 1%, 2.2% in the other direction.

### Example 8

An actuator that has been prepared according to example 2 but is different due to the fact that the voltage applied is between 0.1 V and 5 V.

Measuring Methods

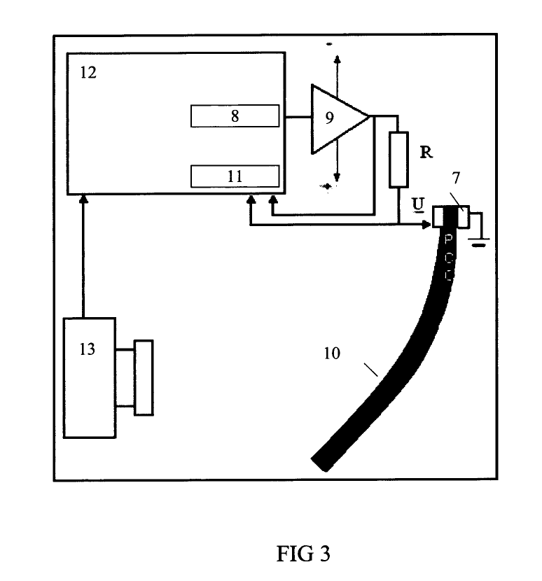

The scheme of the measuring system used for measuring the characteristics of the actuator made of the composite material is depicted on FIG. 3. This system allows for applying current impulses of very precise shape and duration to the actuator, and it records the extent of the movement, its force, the current consumed and the voltage applied.

A fastener 7 with special gold contacts was used to fix the actuator (10) into vertical position. The voltage required for making the actuator bend was generated by a code-analogue converter (8). As the output voltage of NI PCI-6703 analogue output board is low, it was enhanced by NS LM675 power operational amplifier (9). The signal was applied to the actuator via a contact (U). The voltage was recorded by 16-bit NI PCI-6034 data acquisition board (11). The input amperage of the actuator was determined on the basis of the voltage drop in the resistor R. All measurements were taken using National Instruments LabView 7 control software (12). The movements of the actuator were recorded by Point Grey Dragonfly Express camera (3.75 fps) (13). The camera was directed crosswise to the movement of the actuator and the background was lighted through translucent glass in front of which was graph paper. The frame where the position of the actuator was the furthest of the equilibrium was used to calculate the parameters of the extent of movement.

The extent of movement of the actuator is measured in strains, which are calculated according to the following formula (1):

$$ɛ = \frac{2 d δ}{{L}^{2} + {δ}^{2}} , \qquad ( 1 )$$

where L is the length of the moving part of the actuator, d is the thickness of the actuator and δ is the deviance (distance) from the equilibrium.

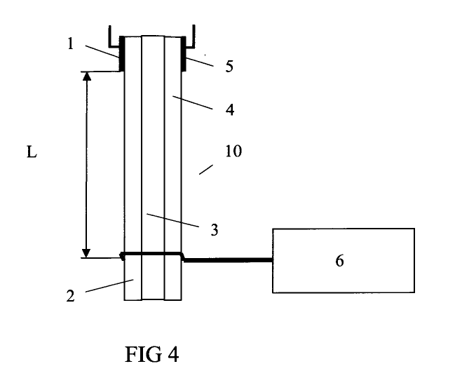

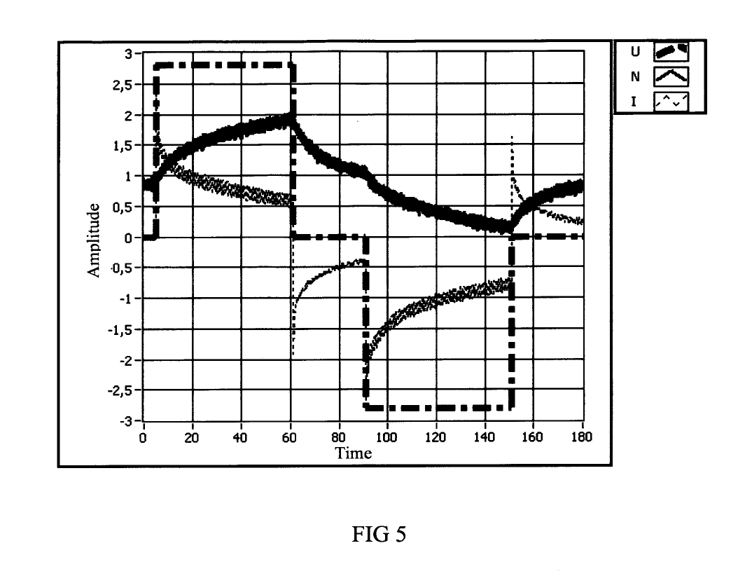

The force generated by the actuator was measured by Panlab MLT0202 force transducer (6), which had been connected to the vertically positioned actuator (10) 13 mm away (L) from the contacts (see FIG. 4).

1. A layered actuator, made of composite material, comprising two electrode layers and a membrane of an electronically nonconductive material, wherein the actuator is capable of bending due to repositioning of ions in the membrane when direct current is applied to it, characterized in that at least one of its electrode layers contains carbide-derived carbon.

2. The device according to claim 1, wherein at least one electrode layer contains carbide-derived carbon 5-40% by weight.

3. The device according to claim 2, wherein at least one electrode layer contains carbide-derived carbon 10-35% by weight.

4. The device according to claim 1, wherein at least one electrode layer contains ionic liquid.

5. The device according to claim 4, wherein at least one electrode layer contains polymer material as a binding material.

6. The device according to claim 5, wherein at least one electrode layer contains polymer material 20-35% by weight as a binding material.

7. The device according to claim 4, wherein the polymer material is polyethylene oxide, Nation C₇HF₁₃O₅S. C₂F₄, or polydimethylsiloxane.

8. The device according to claim 4, wherein at least one electrode layer contains ionic liquid 35-50% by weight.

9. The device according to claim 4, wherein the ionic liquid is EMIBF₄ or OMIBF₄ or their mixture.

10. The device according to claim 4, wherein at least one electrode layer is covered with a layer of an electron-conducting material.

11. The device according to claim 1, wherein at least one electrode layer contains activated carbon for improving the conductivity of the electrode layer.

12. The device according to claim 2, wherein at least one electrode layer contains ionic liquid.

13. The device according to claim 3, wherein at least one electrode layer contains ionic liquid.

14. The device according to claim 5, wherein the polymer material is polyethylene oxide, Nation C₇HF₁₃O₅S . C₂F₄, or polydimethylsiloxane.

15. The device according to claim 6, wherein the polymer material is polyethylene oxide, Nation C₇HF₁₃O₅S . C₂F₄, or polydimethylsiloxane.

16. The device according to claim 5, wherein at least one electrode layer contains ionic liquid 35-50% by weight.

17. The device according to claim 6, wherein at least one electrode layer contains ionic liquid 35-50% by weight.

18. The device according to claim 7, wherein at least one electrode layer contains ionic liquid 35-50% by weight.

19. The device according to claim 5, wherein the ionic liquid is EMIBF₄ or OMIBF₄ or their mixture.

20. The device according to claim 6, wherein the ionic liquid is EMIBF₄ or OMIBF₄ or their mixture.
